(19) United States
(12) Patent Application Publication
(10) Pub. No.: US 2013/0177672 A1
(43) Pub. Date: Jul. 11, 2013

(54) BEVERAGES AND EXTRACTS WITH ENHANCEMENTS

(71) Applicants: Urano A. Robinson, Sammamish, WA (US); J. Marcio Da Cruz, Issaquah, WA (US); Dien Van Vu, Kent, WA (US); Joseph Kuo, Seattle, WA (US)

(72) Inventors: Urano A. Robinson, Sammamish, WA (US); J. Marcio Da Cruz, Issaquah, WA (US); Dien Van Vu, Kent, WA (US); Joseph Kuo, Seattle, WA (US)

(73) Assignee: STARBUCKS CORPORATION D/B/A STARBUCKS COFFEE COMPANY, SEATTLE, WA (US)

(21) Appl. No.: 13/344,520

(22) Filed: Jan. 5, 2012

(51) Int. Cl. A23L 1/28; A23F 3/00; A23L 3/44; A23L 3/46; A23L 2/00; A23G 1/00; A23L 1/302; A23L 1/30; A23L 2/38; A23L 1/308; A23F 5/00; A23L 3/40

(52) U.S. Cl. 426/72; 426/655; 426/594; 426/597; 426/593; 426/541; 426/598; 426/590; 426/431; 426/432; 426/435; 426/392

(57) ABSTRACT

Generally described are extracts and beverages with enhanced nutrients, flavors and textures and methods of making the same. Some embodiments relate to extracts and beverages produced through high pressure extraction techniques.

### BACKGROUND

1. Field

The present embodiments generally relate to extracts and beverages with enhanced nutrients, flavors and textures and methods of making the same. Some embodiments relate to extracts and beverages produced through high pressure extraction techniques.

2. Background

A common method of producing an extract and/or a squeezed liquid from an edible substance involves crushing the edible substance and extracting it with hot water using a closed extract column or a kneader. For example, with coffee, after roasting, coffee beans are milled to a smaller size and then held in hot water at about 90° C. or higher for several minutes and then subjected to solid-liquid separation by means of a flannel or mesh filter or roasted whole bean filter bed. In order to extract more desired compounds at higher concentrations, conventional methods such as heating to high temperatures, repeated heating, extended processing times, caustic solvents and others have been utilized.

However, exposure to such harsh conditions used in conventional extraction processes can deteriorate flavors, nutrients, antioxidants, polyphenols, vitamins, flavonoids, phytochemicals, nutraceuticals and other compounds and qualities in the resulting extracts and beverages. Therefore, to achieve improved beverages and extracts, improved methods of extraction are being developed.

### BRIEF DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is a block diagram depicting an illustrative embodiment of a method for preparing an extract of green coffee beans, immature green coffee cherries and/or red coffee cherries;

FIG. 2 is a block diagram depicting an illustrative embodiment of a method for preparing an extract of green tea leaves and/or partially or totally dehydrated tea leaves; and

FIG. 3 is a block diagram depicting an illustrative embodiment of a method for preparing an extract of roasted whole bean coffee.

### DETAILED DESCRIPTION

The following discussion is presented to enable a person skilled in the art to make and use one or more of the present embodiments. The general principles described herein may be applied to embodiments and applications other than those detailed below without departing from the spirit and scope of the disclosure. Therefore, the present embodiments are not intended to be limited to the particular embodiments shown, but are to be accorded the widest scope consistent with the principles and features disclosed or suggested herein.

Many beverage components have been found to contain antioxidants and other health promoting compounds. For example, recent studies indicate that consuming coffee can reduce the risk of Type 2 Diabetes, Parkinson's disease, heart disease, asthma and some forms of cancer. Tea has also been shown to have anti-cancer, anti-diabetes, anti-arthritis and anti-depressant properties. Therefore, much attention has been paid to the various compounds contained in these beverages and their possible uses as health supplements.

During many conventional extraction techniques, high heat, repeated heating, extended processing times and caustic solvents have been used to isolate desired chemical compounds from bulk matter. However, these techniques used in the extraction process can result in low yields and the breakdown of desired compounds within the beverage components. Due to the conventional thinking that extractions are best enhanced by chemically or thermally opening cells to separate compounds from bulk matter, many variations of heat and solvents have been used in attempts to increase yield and obtain more desired compounds from edible sources with little success. Pressure has been used to bring carbon dioxide to its critical point in order to use it as a solvent for supercritical extraction, but such pressures are typically less than 1000 bar and such extractions have not significantly increased yield.

As disclosed herein, methods are provided for preparing extracts of edible substances using high pressure. In some embodiments, high pressure includes pressures of about 2000 bar and higher. While not wishing to be bound by any particular theory, it is believed that high pressure aids in extraction by physically opening cells and intracellular organelles and releasing bound compounds, including some compounds that may not be obtainable using other extraction techniques. In addition, using high pressure allows an efficient and productive extraction at lower temperatures, with shorter processing times than conventional methods, while preventing degradation of desirable compounds and loss of tastes or aromas. High pressure extraction techniques performed at a lower temperature can be as efficient or more efficient than conventional techniques in raising the extraction yield and maintaining desirable compounds in the extract in greater concentrations. These high pressure extraction techniques can also take less processing time than conventional methods, which makes the extraction more efficient and reduces the amount of process to which the edible substance is subjected.

Non-limiting examples of desirable compounds extracted with high pressure in the current embodiment include nutrients, antioxidants, polyphenols, vitamins, flavonoids, phytochemicals, neutraceuticals and other beneficial compounds. In some embodiments, polyphenols include compounds with a phenol ring with one or more hydroxyl groups covalently attached. For example, polyphenols include tannic acid, ellagic acid, vanillin, caffeic acid, chlorogenic acid, ferulic acid, catechins, epicatechin gallate, epigallocatechin, flavonols, anthocyanidins, quercetin, kaempferol, other flavonoids, and their glycosides and depsides. Furthermore, polyphenols may be in oligomeric or polymeric form such as oligomeric proanthocyanidins or condensed tannins.

In some embodiments, an edible substance can be extracted through the following process. First, the edible substance can be optionally pre-frozen and ground if necessary. Then, in some embodiments, the edible substance can be transferred to a plastic bag (e.g. a Scholle type bag) or an extraction chamber and combined with an extraction medium such as water. In some embodiments, the edible substance to extraction medium ratio can be from about 1:1 to about 1:20. In some embodiments, the ratio is about 1:2. In some embodiments, the extraction medium is water. Then the edible substance can be optionally pre-soaked in the extraction medium for from about 5 seconds to about 90 minutes. In some embodiments, the pre-soaking temperature can be from about 1° C. to about 150° C., from about 2° C. to about 100° C., from about 3° C. to about 80° C., from about 4° C. to about 60° C., from about 4° C. to about 50° C., from about 4° C. to about 40° C. or from about 4° C. to about 30° C. In some embodiments, the edible substance is not pre-soaked.

In some embodiments, the edible substance may be coffee, in other embodiments, the edible substance may be green coffee beans. In still other embodiments, the edible substance may be roasted whole coffee beans, for example, dark roast coffee beans or light roast coffee beans. In yet other embodiments, the edible substance may be green tea leaves and/or partially or totally dehydrated tea leaves. In some embodiments, the edible substance may also be, in whole or in part, at least one of green coffee cherries, red coffee cherries, coffee flowers, coffee cherry skin, coffee cherry pulp, coffee cherry stalk, coffee cherry silverskin, coffee cherry mucilage, coffee cherry parchment, coffee cherry exocarp, coffee cherry mesocarp, vanilla beans, chocolate beans, hazelnuts, caramel, cinnamon, mint, eggnog, apple, apricot, aromatic bitters, banana, berry, blackberry, blueberry, celery, cherry, cranberry, strawberry, raspberry, juniper berry, brandy, cachaca, carrot, citrus, lemon, lime, orange, grapefruit, tangerine, coconut, cola, menthol, gin, ginger, licorice, hot, milk, nut, almond, macadamia nut, peanut, pecan, pistachio, walnut, peach, pear, pepper, pineapple, plum, quinine, rum, white rum, dark rum, sangria, shellfish, clam, tea, black tea, green tea, tequila, tomato, vermouth, dry vermouth, sweet vermouth, whiskey, bourbon whiskey, Irish whiskey, rye whiskey, Scotch whisky, Canadian whiskey, red pepper, black pepper, horseradish, wasabi, jalapeno pepper, chipotle pepper essential oils, resins, resinoids, balms, tinctures, soybean oil, coconut oil, palm oil, kern oil, sunflower oil, peanut oil, almond oil, cocoa butter, amyris oil, angelica seed oil, angelica root oil, aniseed oil, valerian oil, basil oil, tarragon oil, eucalyptus citriodora oil, eucalyptus oil, fennel oil, fir needle oil, galbanum oil, galbanum resin, geranium oil, grapefruit oil, guaiac wood oil, guaiac balsam, guaiac balsam oil, helichrysum absolute, helichrysum oil, ginger oil, iris root absolute, iris root oil, jasmin absolute, calmus oil, chamomile oil bleu, chamomile oil roman, carrot seed oil, cascarilla oil, pine needle oil, mint oil, carvi oil, labdanum oil, labdanum absolute, labdanum resin, lavandin absolute, lavandin oil, lavender absolute, lavender oil, lemongrass oil, Bursera penicillata (linaloe) oil, litsea-cubeba oil, bay laurel leaf oil, macis oil, marjoram oil, mandarin oil, massoirinde oil, mimosa absolute, ambrette seed oil, ambrette tincture, muskatelle salbei oil, nutmeg oil, orange blossom absolute, orange oil, oregano oil, palmarosa oil, patchouli oil, perilla oil, parsley leaf oil, parsley seed oil, clove seed oil, peppermint oil, pepper oil, pimento oil, pine oil, poley oil, rose absolute, rose wood oil, rose oil, rosemary oil, sage oil, lavandin, sage oil Spanish, sandalwood oil, celery seed oil, lavender spike oil, star anis oil, styrax oil, tagetes oil, pine needle oil, tea-tree oil, turpentine oil, thyme oil, tolu balm, tonka absolute, tuberose absolute, vanilla extract, violet leaf absolute, verbena oil, vetiver oil, juniper berry oil, wine yeast oil, wormwood oil, wintergreen oil, ylang ylang oil, hyssop oil, civet absolute, cinnamon leaf oil, cinnamon bark oil and any other type of food flavoring or edible substance.

The edible substance can then be transferred to an extraction chamber and extracted under pressure. In some embodiments, the pressure is from about 2000 bar to about 1,000,000 bar, from about 3000 bar to about 200,000 bar, from about 4000 bar to about 200,000 bar, from about 5000 bar to about 50,000 bar or from about 3000 bar to about 10,000 bar. In some embodiments, the extraction pressure is at least about 2000 bar, 2500 bar, 3000 bar, 3500 bar, 4000 bar, 4500 bar, 5000 bar, 6000 bar, 7000 bar, 8000 bar, at 9000 bar, 10,000 bar, 20,000 bar, 30,000 bar, 40,000 bar, 50,000 bar, 60,000 bar, 70,000 bar, 80,000 bar, 90,000 bar or 100,000 bar.

The extraction can be carried out for varying amounts of time depending on the type and amount of the edible substance being extracted. In some embodiments, the extraction can be performed for from about 1 to about 90 minutes, from about 2 to about 40 minutes, from about 2 to about 10 minutes or from about 3 to about 5 minutes. The extraction temperature can also be varied depending on the type and amount of the edible substance being extracted. In some embodiments, the extraction temperature can be from about 1° C. to about 150° C., from about 2° C. to about 100° C., from about 3° C. to about 80° C., from about 4° C. to about 60° C., from about 4° C. to about 50° C., from about 4° C. to about 40° C. or from about 4° C. to about 30° C. In some embodiments, the temperature fluctuates during the extraction. In some embodiments, if the edible substance is frozen when extraction begins, the temperature of the edible substance and the extraction medium may be different and may equilibrate during the extraction process.

After extraction, the resulting material can be optionally post-soaked in the extraction medium for from about 5 seconds to about 90 minutes. In some embodiments, the post-soaking temperature can be from about 1° C. to about 150° C., from about 2° C. to about 100° C., from about 3° C. to about 80° C., from about 4° C. to about 60° C., from about 4° C. to about 50° C., from about 4° C. to about 40° C. or from about 4° C. to about 30° C. The extraction chamber or bag can then be drained, the liquid extract maintained and the spent solid material either discarded or maintained for other uses, for example, agricultural purposes. In some embodiments, the spent solid material can undergo one or more additional passes of optional pre-soaking, extraction and post-soaking as described above. The resulting liquid extract from the one ore more additional extractions can be combined with the original liquid extract for processing or processed separately. After extraction, the liquid extract can then be concentrated, filtered and dried as discussed below. The dried product can be ground to a mean particle size of from about 1 to about 5000 microns, about 2 to about 1000 microns, about 3 to about 500 microns, about 4 to about 400 microns or from about 5 to about 300 microns and packaged as discussed below.

Heat is also sometimes used to sterilize extracts and beverages, but such heat can be damaging to the compounds in the extract and detrimental to the taste of a beverage. However, in order to be shelf-stable, the extract or beverage should be substantially free of microorganisms. One method of removing such microorganisms and other contaminants, which can be done without high heat or repeated heating is filtration. Different types of filtration can be used with or without heat to remove bacteria, excess water, high molecular weight proteins and other contaminants from liquids. Accordingly, extract components can be filtered using membrane filtration as a no heat or low heat alternative method of removing unwanted bacteria and other contaminants.

Non-limiting examples of materials used for such membrane filters include cellulose acetates, ceramics, cellulose esters, polyamides, etc. The types of filtration are also not limited and include, for example, nanofiltration, ultrafiltration, microfiltration, reverse osmosis filtration, and any combination of these. Membrane filters can be obtained from Koch Filter Corporation (Louisville, Ky.) or Millipore Inc. (Billerica, Mass.), for example. Non-limiting examples of suitable membrane filters are a ROMICON® filter made by Koch or an AMICON® filter made by Millipore. Pore diameters of such filters may be from about 0.001 microns to about 0.5 microns and from about <1K to about 500K MWCO (Molecular Weight Cut-Off). In some embodiments, the edible substance or extract is filtered using microfiltration to remove bacteria, protein and high molecular weight particles. In other embodiments a combination of filtration methods such as reverse osmosis, nanofiltration, ultrafiltration and microfiltration is used. Membrane filters can also be used in the present embodiments to concentrate solutions and remove water, salts and proteins, for example. After filtration, the materials such as bacteria and high molecular weight proteins blocked by the filter can be maintained or discarded. The liquid passing through the filter is usually maintained as the product of the filtration. In some embodiments, the extract component contains significantly less bacteria and other contaminants after being subjected to a filtration process.

In order to facilitate filtration and other processing of an extract component, the extract component can be concentrated by removing water and salts, for example. In addition, concentration of beverage components can make the beverage component easier to process, sterilize, transport and store. In some embodiments, the extract component can be concentrated using the above-described filtration techniques. In other embodiments, the extract component can be concentrated using other techniques, such as freeze concentration. Freeze concentration involves concentration by partial freezing of an edible substance or extract and subsequent separation of the resulting ice crystals leaving a liquid concentrate. Other methods of concentration include low temperature/low pressure gentle thermal evaporation or high vacuum, low temperature evaporation, for example. Some embodiments provide concentration through a combination of the above methods. For example, the edible substance or extract can be concentrated through a combination of membrane filtration and non-membrane concentration. More specifically, concentration of the edible substance or extract can be carried out through a combination of reverse osmosis filtration and freeze concentration. In other embodiments, the edible substance or extract can be concentrated through a combination of different types of filtration such as ultra filtration and reverse osmosis filtration. In still other embodiments, the edible substance or extract can be concentrated through a combination of more than one non-filtration techniques such as a combination of freeze concentration and low temperature/low pressure gentle thermal evaporation.

Drying the extract after extraction should be done carefully to avoid exposure to high heat, repeated heating or oxygen, which could damage the taste, aroma and compounds of the extract. Also, care should be taken when drying to avoid any conditions which may contaminate the extract with bacteria or other contaminants. Non-limiting examples of methods of drying an extract include freeze drying, spray drying, filter-mat drying, fluid bed drying, vacuum drying, drum drying, zeodration, etc, or any combination thereof. Zeodration involves drying with zeolites. Zeolites are materials containing pores, which allow the passage of water, but do not allow the passage of certain other materials. Drying by zeodration involves placing the wet solution in contact with zeolites, drawing only the water into the zeolites and then removing the zeolites, leaving a dried product.

In some embodiments, vacuum drying can be carried out at from about 0.05 mbar to about 0.5 mbar at a temperature of from about −40° C. to about 0° C. In some embodiments, vacuum drying can be carried out at from about 10 mbar to about 40 mbar at a temperature of from about −20° C. to about 0° C. Freeze drying can be carried out at from about 0.5 mbar to about 50 mbar and at a temperature of from about −20° C. to about 0° C. In addition, if water is to be removed by sublimation, the pressure during freeze drying may be below about 6 mbar and the temperature below about 0° C. In some embodiments, zeodration can be carried out at a pressure of from about 0.1 to about 50 mbar and a temperature of from about 10° C. to about 60° C. Temperature and pressure ranges can be monitored carefully to obtain sublimation of water only, which leaves intact the product flavor, aroma and desired compounds. In one example, the extract can be dried at a temperature lower than about −11° C. to preserve substantially all flavor properties. In some embodiments, the temperature can be below about 0° C. until the last stage of the drying (for example, from about 5% to about 8% moisture) and the temperature can then be raised above about 0° C. In some embodiments, the length of time that the extract undergoes drying is minimized to avoid degradation of flavor.

Though filtration of a liquid can remove significant amounts of bacteria, in order for a liquid to be considered aseptic as required for shelf-stable products, additional sterilization methods are often desirable. Sterilization of the extract can be carried out in many different ways including high pressure sterilization (HP), high temperature short time (HTST) pasteurization, pressure assisted thermal sterilization (PATS) and thermal assisted pressure sterilization (TAPS). When TAPS is performed, many of the bacteria in the liquid are killed by the increased pressure of the process. Therefore, with a properly filtered, concentrated and otherwise prepared extract, TAPS can often result in an aseptic product, which has not been heated over a certain temperature. In some embodiments, TAPS can be performed at a temperature of from about 60° F. to about 150° F., a pressure of from about 3000 bar to about 9000 bar and for a time from about 30 seconds to about 10 minutes. In other embodiments, TAPS can be performed at a temperature of from about 80° F. to about 140° F., a pressure of from about 3000 bar to about 9000 bar and for a time from about 1 minute to about 6 minutes. PATS involves bringing the extract to a high temperature, however, in contrast with conventional sterilization methods, PATS may only heat the extract component over a certain temperature one time, which results more desirable qualities of a resulting extract or beverage such as taste and concentration of desirable compounds. PATS can be performed at a temperature of from about 250° F. to about 350° F., a pressure of from about 3000 bar to about 9000 bar and for a time from about 30 seconds to about 10 minutes. In some embodiments, one or more steps described above for TAPS and PATS can be incorporated into the methods of extraction provided herein. As such, some embodiments relate to an extraction/sterilization method utilizing the above steps and values for each in any combination.

The above-described methods of extracting and processing an edible substance can be performed in many different combinations and with a wide variety of variables. For example, in some embodiments all of filtration, concentration, sterilization and drying are used in the preparation of an extract. In other embodiments, only filtration, concentration and sterilization are used. In still other embodiments, only filtration and concentration are used. In yet other embodiments, only concentration and drying are used. In some embodiments, concentration, sterilization and drying are used.

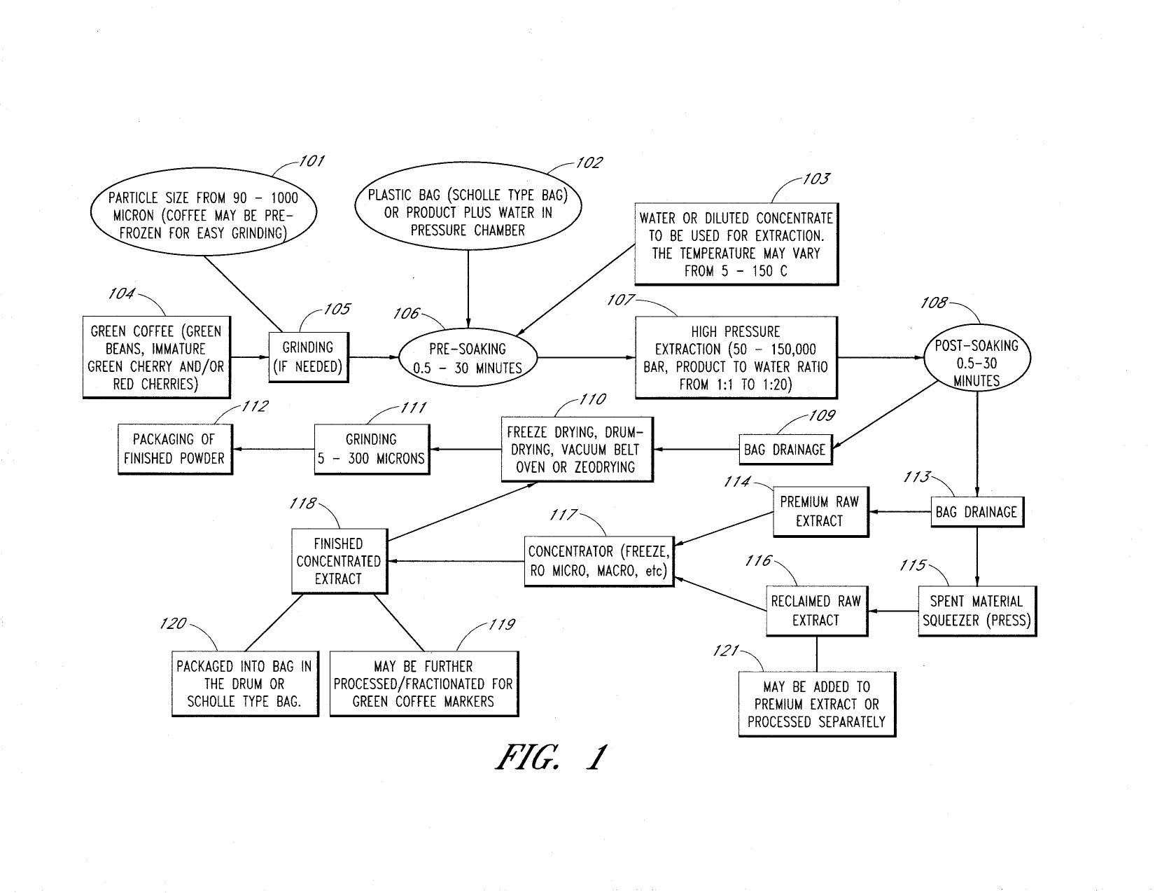

FIGS. 1-3 below illustrate example embodiments in which particular combinations and variables are used in extraction processes. However, the following are in no way meant to limit the scope of the present embodiments, which cover modifications and equivalent arrangements included within the spirit and scope of the appended claims. It should be understood that the values disclosed below are for illustrative purposes and may vary without departing from the scope of the present disclosure. Each example embodiment will be addressed in turn below with reference to the accompanying figures.

FIG. 1 shows an overview of one embodiment of a method for preparing an extract of green coffee beans, immature green coffee cherries and/or red coffee cherries. In this embodiment, green coffee beans, immature green coffee cherries and/or red coffee cherries to be extracted as shown in block 104 can undergo grinding if needed as shown in block 105. As shown in block 101, the resulting particle size after grinding is 90 to 1000 micron and the coffee can be pre-frozen before grinding if desired. The ground product is then placed in a plastic bag, such as a Scholle type bag, or directly into a pressure chamber as shown in block 102. Optionally, the ground product can be pre-soaked as shown in block 106 for 0.5 to 30 minutes. The temperature for pre-soaking can be from 5 to 150° C. as shown in block 103. Then the ground product undergoes extraction under a pressure of 50 to 150,000 bar with a product to water ratio of from 1:1 to 1:20 as shown in block 107. After extraction, the product can optionally undergo post-soaking for 0.5 to 30 minutes as shown in block 108. The liquid from the bag or chamber is then drained as shown in block 109 and then can then be dried by any number of alternative drying methods as shown in block 110. Non-limiting examples of drying methods include spray drying, freeze drying or any other type of drying such as filter-mat drying, fluid bed drying, vacuum drying, drum drying, zeodration, a combination thereof etc. The dried product from block 110 is then ground to a size of 5 to 300 micron as shown in block 111 and packaged as shown in block 112. Alternatively, the liquid from the bag or chamber, after optional post-soaking as shown in block 108, can be drained as shown in block 113, separated into spent material as shown in block 115 and premium raw extract as shown in block 114. The spent material as shown in block 115 can either be discarded (not shown) or undergo one or more additional extractions to produce reclaimed extract as shown in block 116, which can be added to the premium extract or processed separately as shown in block 121. The premium raw extract shown in 114 and/or the reclaimed raw extract shown in 116 can be concentrated as shown in block 117 by freeze concentration, reverse osmosis, microfiltration, macrofiltration or a combination thereof, for example, to produce a finished concentrated extract as shown in block 118, which can be packaged in a Scholle type bag as a liquid extract as shown in block 120, further processed or fractionated for green coffee markers as shown in block 119. Alternatively, the finished concentrated extract shown in block 118 can undergo drying as shown in block 110, grinding as shown in block 111 and packaging as a powder as shown in block 112.

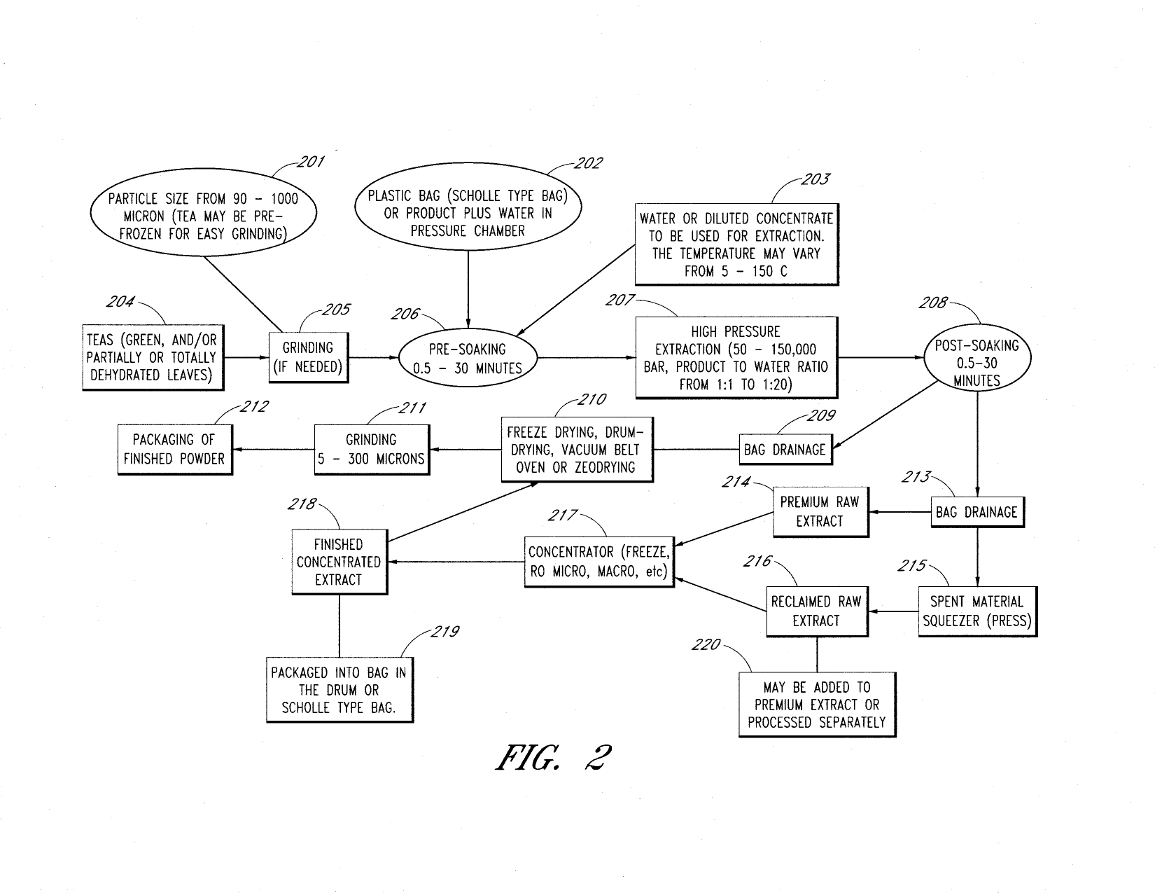

FIG. 2 shows an overview of one embodiment of a method for preparing an extract of green tea leaves and/or partially or totally dehydrated tea leaves. In this embodiment, green tea leaves and/or partially or totally dehydrated tea leaves to be extracted as shown in block 204 can undergo grinding if needed as shown in block 205. As shown in block 201, the resulting particle size after grinding is 90 to 1000 micron and the tea can be pre-frozen before grinding if desired. The ground product is then placed in a plastic bag, such as a Scholle type bag, or directly into a pressure chamber as shown in block 202. Optionally, the ground product can be pre-soaked as shown in block 206 for 0.5 to 30 minutes. The temperature for pre-soaking can be from 5 to 150° C. as shown in block 203. Then the ground product undergoes extraction under a pressure of 50 to 150,000 bar with a product to water ratio of from 1:1 to 1:20 as shown in block 207. After extraction, the product can optionally undergo post-soaking for 0.5 to 30 minutes as shown in block 208. The liquid from the bag or chamber is then drained as shown in block 209 and then can then be dried by any number of alternative drying methods as shown in block 210. Non-limiting examples of drying methods include spray drying, freeze drying or any other type of drying such as filter-mat drying, fluid bed drying, vacuum drying, drum drying, zeodration, a combination thereof, etc. The dried product from block 210 is then ground to a size of 5 to 300 micron as shown in block 111 and packaged as shown in block 212. Alternatively, the liquid from the bag or chamber, after optional post-soaking as shown in block 208, can be drained as shown in block 213, separated into spent material as shown in block 215 and premium raw extract as shown in block 214. The spent material as shown in block 215 can either be discarded (not shown) or undergo one or more additional extractions to produce reclaimed extract as shown in block 216, which can be added to the premium extract or processed separately as shown in block 221. The premium raw extract shown in 214 and/or the reclaimed raw extract shown in 216 can be concentrated as shown in block 217 by freeze concentration, reverse osmosis, microfiltration, macrofiltration or a combination thereof, for example, to produce a finished concentrated extract as shown in block 218, which can be packaged in a Scholle type bag as a liquid extract as shown in block 219. Alternatively, the finished concentrated extract shown in block 218 can undergo drying as shown in block 210, grinding as shown in block 211 and packaging as a powder as shown in block 212.

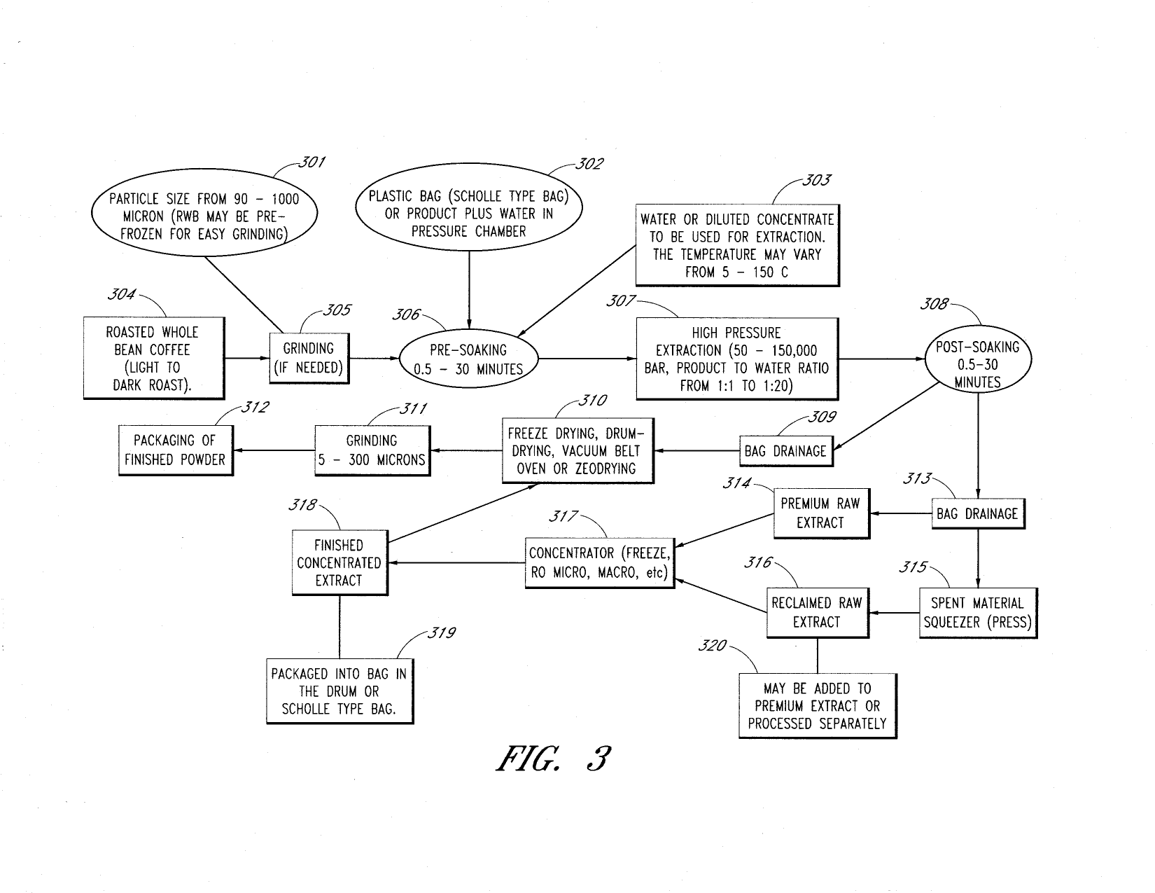

FIG. 3 shows an overview of one embodiment of a method for preparing an extract of roasted whole coffee beans. In this embodiment, roasted whole coffee beans to be extracted as shown in block 304 can undergo grinding if needed as shown in block 305. As shown in block 301, the resulting particle size after grinding is 90 to 1000 micron and the tea can be pre-frozen before grinding if desired. The ground product is then placed in a plastic bag, such as a Scholle type bag, or directly into a pressure chamber as shown in block 302. Optionally, the ground product can be pre-soaked as shown in block 306 for 0.5 to 30 minutes. The temperature for pre-soaking can be from 5 to 150° C. as shown in block 303. Then the ground product undergoes extraction under a pressure of 50 to 150,000 bar with a product to water ratio of from 1:1 to 1:20 as shown in block 307. After extraction, the product can optionally undergo post-soaking for 0.5 to 30 minutes as shown in block 308. The liquid from the bag or chamber is then drained as shown in block 309 and then can then be dried by any number of alternative drying methods as shown in block 310. Non-limiting examples of drying methods include spray drying, freeze drying or any other type of drying such as filter-mat drying, fluid bed drying, vacuum drying, drum drying, zeodration, a combination thereof, etc. The dried product from block 310 is then ground to a size of 5-300 micron as shown in block 311 and packaged as shown in block 312. Alternatively, the liquid from the bag or chamber, after optional post-soaking as shown in block 308, can be drained as shown in block 313, separated into spent material as shown in block 315 and premium raw extract as shown in block 314. The spent material as shown in block 315 can either be discarded (not shown) or undergo one or more additional extractions to produce reclaimed extract as shown in block 316, which can be added to the premium extract or processed separately as shown in block 321. The premium raw extract shown in 314 and/or the reclaimed raw extract shown in 316 can be concentrated as shown in block 317 by freeze concentration, reverse osmosis, microfiltration, macrofiltration or a combination thereof, for example, to produce a finished concentrated extract as shown in block 318, which can be packaged in a Scholle type bag as a liquid extract as shown in block 319. Alternatively, the finished concentrated extract shown in block 318 can undergo drying as shown in block 310, grinding as shown in block 311 and packaging as a powder as shown in block 312.

In some embodiments, sugar can be added to the extract or beverage at any time during processing, such as before extraction, during extraction, after extraction, during drying, after drying, after grinding or after packaging. Non-limiting examples of sugar include cane sugar, fructose, corn syrup, dextrose, malto-dextrose, maltodextrin, glycerine, threitol, erythritol, xylitol, arabitol, ribitol, sorbitol, mannitol, maltitol, maltotriitol, maltotetraitol, lactitol, hydrogenated isomaltulose, hydrogented starch, shellac, ethyl cellulose, hydroxy propyl methylcellulose, starches, modified starches, carboxyl cellulose, carrageenan, cellulose acetate phthalate, cellulose acetate trimellitate, chitosan, corn syrup solids, dextrins, fatty alcohols, hydroxy cellulose, hydroxy ethyl cellulose, hydroxy methyl cellulose, hydroxy propyl cellulose, hydroxy propyl ethyl cellulose, hydroxy propyl methyl cellulose, hydroxy propyl methyl cellulose phthalate, polyethylene glycol or a combination thereof.

Also, additional flavoring can be added to the extract or beverage at any time during processing, such as before extraction, during extraction, after extraction, during drying, after drying, after grinding or after packaging. Non-limiting examples of flavoring include vanilla, chocolate, hazelnut, caramel, cinnamon, mint, eggnog, apple, apricot, aromatic bitters, banana, berry, blackberry, blueberry, celery, cherry, cranberry, strawberry, raspberry, juniper berry, brandy, cachaca, carrot, citrus, lemon, lime, orange, grapefruit, tangerine, coconut, cola, menthol, gin, ginger, licorice, hot, milk, nut, almond, macadamia nut, peanut, pecan, pistachio, walnut, peach, pear, pepper, pineapple, plum, quinine, rum, white rum, dark rum, sangria, shellfish, clam, tea, black tea, green tea, tequila, tomato, top note, tropical, vermouth, dry vermouth, sweet vermouth, whiskey, bourbon whiskey, Irish whiskey, rye whiskey, Scotch whisky, Canadian whiskey, red pepper, black pepper, horseradish, wasabi, jalapeno pepper, chipotle pepper essential oils, concretes, absolutes, resins, resinoids, balms, tinctures, soybean oil, coconut oil, palm oil, kern oil, sunflower oil, peanut oil, almond oil, cocoa butter, amyris oil, angelica seed oil, angelica root oil, aniseed oil, valerian oil, basil oil, tarragon oil, eucalyptus citriodora oil, eucalyptus oil, fennel oil, fir needle oil, galbanum oil, galbanum resin, geranium oil, grapefruit oil, guaiac wood oil, guaiac balsam, guaiac balsam oil, helichrysum absolute, helichrysum oil, ginger oil, iris root absolute, iris root oil, jasmin absolute, calmus oil, chamomile oil bleu, chamomile oil roman, carrot seed oil, cascarilla oil, pine needle oil, mint oil, carni oil, labdanum oil, labdanum absolute, labdanum resin, lavandin absolute, lavandin oil, lavender absolute, lavender oil, lemongrass oil, Bursera penicillata (linaloe) oil, litsea-cubeba oil, bay laurel leaf oil, macis oil, marjoram oil, mandarin oil, massoirinde oil, mimosa absolute, ambrette seed oil, ambrette tincture, muskatelle salbei oil, nutmeg oil, orange blossom absolute, orange oil, oregano oil, palmarosa oil, patchouli oil, perilla oil, parsley leaf oil, parsley seed oil, clove seed oil, peppermint oil, pepper oil, pimento oil, pine oil, poley oil, rose absolute, rose wood oil, rose oil, rosemary oil, sage oil, lavandin, sage oil Spanish, sandalwood oil, celery seed oil, lavender spike oil, star anis oil, styrax oil, tagetes oil, pine needle oil, tea-tree oil, turpentine oil, thyme oil, tolu balm, tonka absolute, tuberose absolute, vanilla extract, violet leaf absolute, verbena oil, vetiver oil, juniper berry oil, wine yeast oil, wormwood oil, wintergreen oil, ylang ylang oil, hyssop oil, civet absolute, cinnamon leaf oil, cinnamon bark oil etc. any other type of food flavoring or edible substance or a combination thereof.

In some embodiments, the extract can also be combined with soluble or instant coffee. Coffee and other products subjected to processing such as that necessary to make an instant form of the product go through flavor and aroma changes. These changes come from the altering of the initial bonded structures of the compounds within the products. With coffee, for example, any kind of processing can alter the bonded structures of the compounds found in unprocessed coffee beans. Some embodiments include a method of adding or restoring the flavor and aroma associated with an unprocessed food product to a processed or instant version of the product. In some embodiments, the product is coffee. Some embodiments include methods involving pulverization of an edible substance, for example, roasted coffee beans, green tea leaves and/or partially or totally dehydrated tea leaves, cocoa beans or other food ingredients as a means of adding or restoring freshness, flavor and aroma of, for example, soluble coffee, teas, chocolates, etc. Some embodiments also allow for the introduction of different and unique flavors and aromas into food products as well as the introduction of compounds from extracts into food and beverage products.

In some embodiments, the pulverized edible substance or extract has a mean particle size, in diameter, of less than about 2000 microns, 1500 microns, 1000 microns 900 microns, 800 microns, 700 microns, 600 microns, 500 microns, 450 microns, 400 microns, 350 microns, 300 microns, 250 microns in diameter, 200 microns, 150 microns, 100 microns, or 50 microns.

In some embodiments, the pulverized edible substance or extract has a median particle size, in diameter, of less than about 2000 microns, 1500 microns, 1000 microns 900 microns, 800 microns, 700 microns, 600 microns, 500 microns, 450 microns, 400 microns, 350 microns, 300 microns, 250 microns in diameter, 200 microns, 150 microns, 100 microns, or 50 microns.

Extract exposure to oxygen can be minimized using conventional methods, for example, nitrogen purging, vacuum packaging, etc. Also, liquid nitrogen can be used as an oxygen scavenger during processing to minimize the degradative effects of oxygen.

Any type of grinding equipment can be used in the present embodiments to grind the edible substance, as shown for example in block 105 of FIG. 1 or to grind the extract, as shown, for example, in block 111 of FIG. 1. Non-limiting examples of grinding equipment include a cage mill, a hammer mill, a single-stage roller grinder, a multistage roller grinder, etc. In some embodiments, the equipment is maintained at very low temperatures (−50° C. to 20° C.) via cooling media. This helps maintain the integrity of the substance being pulverized or ground. Liquid nitrogen and/or carbon dioxide or other refrigerants can be used to cool the equipment. Grinding generates heat, which combined with exposed oxygen, can often degrade the extract product. Feeding liquid nitrogen and/or carbon dioxide to the grinding cavity is one example of a way to keep the grinding machine at low temperatures as well as displacing and scavenging oxygen.

Some embodiments include packaging the extract as shown, for example in block 112 of FIG. 1. In some embodiments the ground or pulverized extract product falls into a refrigerated container at from about 0° C. to about 20° C. In some embodiments the ground or pulverized product falls into a refrigerated container at less than about 20° C. Some embodiments involve using liquid nitrogen and/or carbon dioxide cooling of the container including liquid or gas nitrogen inside the container for product preservation. Other embodiments involve liquid or gas carbon dioxide, CO₂ pellets, liquid or gas argon, air or other inert gases. During operation, the discharging cavity should be continually flushed with gaseous nitrogen to minimize oxidation. In some embodiments, the operation takes place under controlled environmental conditions to protect the resulting product from moisture uptake.

In some embodiments, in order to ensure quality, the final product is moved to an oxygen free environment, vacuum packed, sealed and stored under deep freeze conditions (about −20° C. or colder), until used or sold.

In some embodiments, the integrity of the extract can also be protected by means of encapsulation (e.g. spray-drying, coating, extrusion, coacervation and molecular inclusion) at any time during processing, such as before extraction, during extraction, after extraction, during drying, after drying, after grinding or after packaging. Some embodiments utilize microencapsulation. With encapsulation, an encasing layer is attained, for example, via molecular, interfacial, colloidal and bulk physicochemical properties of emulsions. The encasement reduces the reactivity of the core with regard to outside environment, for example, oxygen and water. This permits the extension of shelf life of a product in conventional packaging applications. In some embodiments, encapsulation can be used for controlled release of the inner material or core. The encased pulverized product can remain inactive until direct contact with water. Then the water can dissolve the encasement and the pulverized product is able to react with water, releasing aromas and flavors.

In some embodiments, the encapsulation of the extract can be used to optimize product functionality, particle size and/or create a new product form. Encapsulation can be done with one or more products including, for example, coffee, coffee extracts, coffee concentrates, dry pulverized coffee, coffee oils or other oils, aromas, functional ingredients, carbohydrates, soy products, dairy products, corn syrup, hydrocolloids, polymers, waxes, fats, vegetable oils, gum arabic, lecithin, sucrose-esters, mono-diglycerides, pectin, K-carbonate, K-bicarbonate, Na-carbonate, Na₃PO₄, K₃PO₄, maltodextrin, glycerine, threitol, erythritol, xylitol, arabitol, ribitol, sorbitol, mannitol, maltitol, maltotriitol, maltotetraitol, lactitol, hydrogenated isomaltulose, hydrogented starch, liposomes, liposomes in sol-gels, shellac, hydrolyzed fats, ethyl cellulose, hydroxy propyl methylcellulose, starches, modified starches, alginate and alginic acid (e.g., sodium alginate), calcium caseinate, calcium polypectate, carboxyl cellulose, carrageenan, cellulose acetate phthalate, cellulose acetate trimellitate, chitosan, corn syrup solids, dextrins, fatty acids, fatty alcohols, gelatin, gellan gums, hydroxy cellulose, hydroxy ethyl cellulose, hydroxy methyl cellulose, hydroxy propyl cellulose, hydroxy propyl ethyl cellulose, hydroxy propyl methyl cellulose, hydroxy propyl methyl cellulose phthalate, lipids, liposomes, low density polyethylene, mono-, di- and tri-glycerides, pectins, phospholipids, polyethylene glycol, polylactic polymers, polylactic co-glycolic polymers, polyvinyl pyrrolindone, stearic acid and derivatives, xanthum and proteins, zein, gluten or other agents to protect against environmental elements.

In addition, during processing of the extract, it is possible to incorporate at least one additive to the extract at any time during processing, such as before extraction, during extraction, after extraction, during drying, after drying, after grinding or after packaging. Some examples of suitable additives include a coffee extract, concentrated coffee, dried coffee, soluble coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, wellness components, lycopene, selenium, a beta-carotene, resveratrol, inulin, beta glucan, 1-3,1-6-beta-glucan, barley beta-glucan, barley b-glucan, a vegetable extract, a dry green coffee extract, a wet green coffee extract, pulverized coffee, ground coffee and an herbal extract, for example. Some embodiments relate to methods of creating a beverage including the extract and additional ingredients.

Some embodiments involve drying the extract as shown in block 110 of FIG. 1. Examples of drying include spray freezing or spray freeze drying the extract or one or more components of a beverage. In some embodiments, spray freezing is used to convert liquid into an instant dry powder in a two step process. In the first step, liquid is sprayed or atomized over a frozen system/medium to freeze the liquid droplets. For example, one technique is to spray the liquid into a frozen chamber (e.g., in some embodiments the frozen chamber is at a temperature of less than about −30° C.) or a frozen conveyor belt. Another technique is to spray the liquid directly over (or into) liquefied gas, e.g., nitrogen, CO₂, argon, and/or other noble or inert gases contained in an appropriate container, such as, for example, a stainless steel receptacle.

The second step of the process involves transferring the frozen droplets onto shelves of a pre-frozen freeze dryer (e.g., in some embodiments, the pre-frozen freeze dryer is at a temperature of less than about −30° C.) to remove moisture via a pre-designed drying cycle. If the droplets retain any liquefied gases after the transfer, the gas can be allowed to evaporate before the freeze drying cycle is started. In another embodiment, the droplets are transferred to equipment for alternative drying, such as freeze drying, filter-mat drying, fluid bed drying, spray drying, thermal evaporation and zeodration, etc. In some embodiments, the droplets can be sprayed onto a fluidized bed of frozen/cryogenic fluids, e.g., helium, CO₂, nitrogen or the like, in a chamber/dryer. An inert gas, a noble gas or nitrogen may be used to fluidize the frozen bed and drive out moisture via sublimation, which is then trapped onto the surface of condenser coils, which are kept at a temperature of less than about −40° C., for example. In some embodiments, the temperature of the fluidizing gas is kept below the eutectic point of the frozen droplets in order to avoid melt back and/or flavor degradation. Spray freeze drying can be used to increase bulk powder flowability, improve control of particle size distribution, improve solubility and reduce thermal flavor degradation. Some embodiments also involve non-thermal evaporation or high vacuum, low temperature evaporation in the drying process.

In some embodiments, spray freezing may utilize different nozzle designs (for example, two-fluid nozzles, pressure nozzles, or ultra-sonic nozzles,) which can be used to atomize the liquid concentrate into the frozen system without becoming clogged. The size and/or shape of the spray freeze chamber, the gas inlet/outlet temperatures, the concentrate flow rates, the gas flow rates, the mode of cooling/liquefied gas, the mode of atomization, etc, can all be modified depending on the type of beverage component undergoing spray freezing or spray freeze drying and the desired beverage product.

The following examples are provided for illustrative purposes only, and are in no way intended to limit the scope of the present embodiments.

### Example 1

Tea leaves were ground to a particle size of from 90 μm to 1000 μm in a standard cage mill grinder. The ground product was placed in a Scholle type bag and water was added to the ground product. The ratio of product to water was 1:2. Extraction of the ground product was then carried out at a temperature of 32° C., at a pressure of 2000 bar for two minutes. The Scholle type bag was then drained and the solid spent material discarded. The raw liquid extract was then concentrated, dried and ground to form a final tea extract powder.

### Example 2

Tea leaves were ground to a particle size of from 90 μm to 1000 μm in a standard cage mill grinder. The ground product was placed in a Scholle type bag and water was added to the ground product. The ratio of product to water was 1:4. Pre-soaking was carried out for five minutes at a temperature of 15° C. Extraction of the ground product was then carried out at a temperature of 32° C., at a pressure of 2600 bar for two minutes. Post-soaking was carried out for five minutes at a temperature of 15° C. The Scholle type bag was then drained and the solid spent material discarded. The raw liquid extract was then concentrated, dried and ground to form a final tea extract powder.

### Example 3

Tea leaves were ground to a particle size of from 90 μm to 1000 μm in a standard cage mill grinder. The ground product was placed in a Scholle type bag and water was added to the ground product. The ratio of product to water was 1:6. Pre-soaking was carried out for five minutes at a temperature of 32° C. Extraction of the ground product was then carried out at a temperature of 32° C., at a pressure of 2600 bar for two minutes. Post-soaking was carried out for five minutes at a temperature of 32° C. The Scholle type bag was then drained and the solid spent material discarded. The raw liquid extract was then concentrated, dried and ground to form a final tea extract powder.

### Example 4

Tea leaves were ground to a particle size of from 90 μm to 1000 μm in a standard cage mill grinder. The ground product was placed in a Scholle type bag and water was added to the ground product. The ratio of product to water was 1:6. Pre-soaking was carried out for five minutes at a temperature of 32° C. Extraction of the ground product was then carried out at a temperature of 70° C., at a pressure of 2600 bar for five minutes. Post-soaking was carried out for five minutes at a temperature of 32° C. The Scholle type bag was then drained and the solid spent material discarded. The raw liquid extract was then concentrated, dried and ground to form a final tea extract powder.

### Example 5

Tea leaves were ground to a particle size of from 90 μm to 1000 μm in a standard cage mill grinder. The ground product was placed in a Scholle type bag and water was added to the ground product. The ratio of product to water was 1:6. Pre-soaking was carried out for five minutes at a temperature of 32° C. Extraction of the ground product was then carried out at a temperature of 70° C., at a pressure of 4000 bar for ten minutes. Post-soaking was carried out for five minutes at a temperature of 32° C. The Scholle type bag was then drained and the solid spent material discarded. The raw liquid extract was then concentrated, dried and ground to form a final tea extract powder.

### Example 6

Tea leaves were ground to a particle size of from 90 μm to 1000 μm in a standard cage mill grinder. The ground product was placed in a Scholle type bag and water was added to the ground product. The ratio of product to water was 1:6. Pre-soaking was carried out for five minutes at a temperature of 32° C. Extraction of the ground product was then carried out at a temperature of 70° C., at a pressure of 4000 bar for 15 minutes. Post-soaking was carried out for five minutes at a temperature of 32° C. The Scholle type bag was then drained and the solid spent material discarded. The raw liquid extract was then concentrated, dried and ground to form a final tea extract powder.

### Example 7

Tea leaves were ground to a particle size of from 90 μm to 1000 μm in a standard cage mill grinder. The ground product was placed in a Scholle type bag and water was added to the ground product. The ratio of product to water was 1:8. Pre-soaking was carried out for five minutes at a temperature of 32° C. Extraction of the ground product was then carried out at a temperature of 70° C., at a pressure of 4000 bar for 15 minutes. Post-soaking was carried out for five minutes at a temperature of 32° C. The Scholle type bag was then drained and the solid spent material discarded. The raw liquid extract was then concentrated, dried and ground to form a final tea extract powder.

### Example 8

Tea leaves were ground to a particle size of from 90 μm to 1000 μm in a standard cage mill grinder. The ground product was placed in a Scholle type bag and water was added to the ground product. The ratio of product to water was 1:8. Pre-soaking was carried out for five minutes at a temperature of 32° C. Extraction of the ground product was then carried out at a temperature of 70° C., at a pressure of 4000 bar for 15 minutes, Post-soaking was carried out for five minutes at a temperature of 32° C. The Scholle type bag was then drained and the solid spent material discarded. The raw liquid extract was then concentrated, dried and ground to form a final tea extract powder.

### Example 9

Tea leaves were ground to a particle size of from 90 μm to 1000 μm in a standard cage mill grinder. The ground product was placed in a Scholle type bag and water was added to the ground product. The ratio of product to water was 1:12. Pre-soaking was carried out for five minutes at a temperature of 32° C. Extraction of the ground product was then carried out at a temperature of 70° C., at a pressure of 4000 bar for 15 minutes. Post-soaking was carried out for five minutes at a temperature of 32° C. The Scholle type bag was then drained and the solid spent material discarded. The raw liquid extract was then concentrated, dried and ground to form a final tea extract powder.

### Example 10

Black tea leaves were ground to a particle size of from 90 μm to 1000 μm in a standard cage mill grinder. The ground product was placed in a Scholle type bag and water was added to the ground product. The ratio of product to water was 1:6. Pre-soaking was carried out for five minutes at a temperature of 32° C. Extraction of the ground product was then carried out at a temperature of 32° C., at a pressure of 6000 bar for 3 minutes. Post-soaking was carried out for five minutes at a temperature of 32° C. The Scholle type bag was then drained and the solid spent material discarded. These conditions resulted in an extract with 8.4% soluble solids and yield of 45.8%. The raw liquid extract was then concentrated, dried and ground to form a final tea extract powder.

### Example 11

Green coffee beans, immature green coffee cherries and mature red coffee cherries were ground to a particle size of from 90 μm to 1000 μm in a standard cage mill grinder. The ground product was placed in a Scholle type bag and water was added to the ground. The ratio of product to water was 1:1. Extraction of the ground product was then carried out at a temperature of 4° C., at a pressure of 6000 bar for two minutes. The Scholle type bag was then drained and the solid spent material discarded. These conditions yielded an extract with greater than 5% soluble solids. The raw liquid extract was then concentrated, dried and ground to form a final green coffee extract powder.

### Example 12

Green coffee beans, immature green coffee cherries and mature red coffee cherries were ground to a particle size of from 90 μm to 1000 μm in a standard cage mill grinder. The ground product was placed in a Scholle type bag and water was added to the ground. The ratio of product to water was 1:2. Extraction of the ground product was then carried out at a temperature of 4° C., at a pressure of 6000 bar for two minutes. The Scholle type bag was then drained and the solid spent material discarded. These conditions yielded an extract with greater than 5% soluble solids. The raw liquid extract was then concentrated, dried and ground to form a final green coffee extract powder.

### Example 13

Green coffee beans, immature green coffee cherries and mature red coffee cherries were ground to a particle size of from 90 μm to 1000 μm in a standard cage mill grinder. The ground product was placed in a Scholle type bag and water was added to the ground. The ratio of product to water was 1:4. Extraction of the ground product was then carried out at a temperature of 4° C., at a pressure of 6000 bar for three minutes. The Scholle type bag was then drained and the solid spent material discarded. These conditions yielded an extract with greater than 5% soluble solids. The raw liquid extract was then concentrated, dried and ground to form a final green coffee extract powder.

### Example 14

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:2. Pre-soaking was carried out for five minutes at a temperature of 4° C. Extraction of the ground product was then carried out at a temperature of 4° C., at a pressure of 6000 bar for two minutes. Post-soaking was carried out for five minutes at a temperature of 4° C. The Scholle type bag was then drained and the solid spent material discarded. These conditions yielded an extract with greater than 5% soluble solids. The raw liquid extract was then concentrated, dried and ground to form a final green coffee extract powder.

### Example 15

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:2. Pre-soaking was carried out for five minutes at a temperature of 20° C. Extraction of the ground product was then carried out at a temperature of 4° C., at a pressure of 6000 bar for two minutes. Post-soaking was carried out for five minutes at a temperature of 20° C. The Scholle type bag was then drained and the solid spent material discarded. These conditions yielded an extract with greater than 5% soluble solids. The raw liquid extract was then concentrated, dried and ground to form a final green coffee extract powder.

### Example 16

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:1. Extraction of the ground product was then carried out at a temperature of 4° C., at a pressure of 6000 bar for five minutes. The Scholle type bag was then drained and the solid spent material discarded. These conditions yielded an extract with greater than 5% soluble solids. The raw liquid extract was then concentrated, dried and ground to form a final green coffee extract powder.

### Example 17

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:2. Extraction of the ground product was then carried out at a temperature of 4° C., at a pressure of 6000 bar for five minutes. The Scholle type bag was then drained and the solid spent material discarded. These conditions yielded an extract with greater than 5% soluble solids. The raw liquid extract was then concentrated, dried and ground to form a final green coffee extract powder.

### Example 18

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:4. Extraction of the ground product was then carried out at a temperature of 4° C., at a pressure of 6000 bar for five minutes. The Scholle type bag was then drained and the solid spent material discarded. These conditions yielded an extract with greater than 5% soluble solids. The raw liquid extract was then concentrated, dried and ground to form a final green coffee extract powder.

### Example 19

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:2. Pre-soaking was carried out for five minutes at a temperature of 4° C. Extraction of the ground product was then carried out at a temperature of 4° C., at a pressure of 6000 bar for five minutes. Post-soaking was carried out for five minutes at a temperature of 4° C. The Scholle type bag was then drained and the solid spent material discarded. These conditions yielded an extract with greater than 5% soluble solids. The raw liquid extract was then concentrated, dried and ground to form a final green coffee extract powder.

### Example 20

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:2. Pre-soaking was carried out for five minutes at a temperature of 20° C. Extraction of the ground product was then carried out at a temperature of 4° C., at a pressure of 6000 bar for two minutes. Post-soaking was carried out for five minutes at a temperature of 20° C. The Scholle type bag was then drained and the solid spent material discarded. These conditions yielded an extract with greater than 5% soluble solids. The raw liquid extract was then concentrated, dried and ground to form a final green coffee extract powder.

### Example 21

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:1. Extraction of the ground product was then carried out at a temperature of 25° C., at a pressure of 6000 bar for 15 minutes. The Scholle type bag was then drained and the solid spent material discarded. These conditions yielded an extract with greater than 5% soluble solids. The raw liquid extract was then concentrated, dried and ground to form a final green coffee extract powder.

### Example 22

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:2. Extraction of the ground product was then carried out at a temperature of 25° C., at a pressure of 6000 bar for 15 minutes. The Scholle type bag was then drained and the solid spent material discarded. These conditions yielded an extract with greater than 5% soluble solids. The raw liquid extract was then concentrated, dried and ground to form a final green coffee extract powder.

### Example 23

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:4. Extraction of the ground product was then carried out at a temperature of 25° C., at a pressure of 6000 bar for 15 minutes. The Scholle type bag was then drained and the solid spent material discarded. These conditions yielded an extract with greater than 5% soluble solids. The raw liquid extract was then concentrated, dried and ground to form a final green coffee extract powder.

### Example 24

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:2. Pre-soaking was carried out for five minutes at a temperature of 4° C. Extraction of the ground product was then carried out at a temperature of 25° C., at a pressure of 6000 bar for 15 minutes. Post-soaking was carried out for five minutes at a temperature of 4° C. The Scholle type bag was then drained and the solid spent material discarded. These conditions yielded an extract with greater than 5% soluble solids. The raw liquid extract was then concentrated, dried and ground to form a final green coffee extract powder.

### Example 25

Green coffee beans, immature green coffee cherries and mature red coffee cherries were ground to a particle size of from 90 μm to 1000 μm in a standard cage mill grinder. The ground product was placed in a Scholle type bag and water was added to the ground product. The ratio of product to water was 1:2. Pre-soaking was carried out for five minutes at a temperature of 20° C. Extraction of the ground product was then carried out at a temperature of 25° C., at a pressure of 6000 bar for 15 minutes. Post-soaking was carried out for five minutes at a temperature of 20° C. The Scholle type bag was then drained and the solid spent material discarded. These conditions yielded an extract with greater than 5% soluble solids. The raw liquid extract was then concentrated, dried and ground to form a final green coffee extract powder.

### Example 26

Roasted whole coffee beans were ground to a particle size of from 90 μm to 1000 μm in a standard cage mill grinder. The ground product was placed in a Scholle type bag and water was added to the ground product. The ratio of product to water was 1:1. Pre-soaking was carried out for 30 seconds at a temperature of 15° C. Extraction of the ground product was then carried out at a temperature of 15° C., at a pressure of 2000 bar for one minute. Post-soaking was carried out for thirty seconds at a temperature of 15° C. The Scholle type bag was then drained and the solid spent material discarded. The raw liquid extract was then concentrated, dried and ground to form a final roasted coffee extract powder.

### Example 27

Roasted whole coffee beans were ground to a particle size of from 90 μm to 1000 μm in a standard cage mill grinder. The ground product was placed in a Scholle type bag and water was added to the ground product. The ratio of product to water was 1:2. Pre-soaking was carried out for 30 seconds at a temperature of 32° C. Extraction of the ground product was then carried out at a temperature of 32° C., at a pressure of 2000 bar for one minute. Post-soaking was carried out for thirty seconds at a temperature of 32° C. The Scholle type bag was then drained and the solid spent material discarded. The raw liquid extract was then concentrated, dried and ground to form a final roasted coffee extract powder.

### Example 28

Roasted whole coffee beans were ground to a particle size of from 90 μm to 1000 μm in a standard cage mill grinder. The ground product was placed in a Scholle type bag and water was added to the ground product. The ratio of product to water was 1:2. Pre-soaking was carried out for 30 seconds at a temperature of 32° C. Extraction of the ground product was then carried out at a temperature of 70° C., at a pressure of 2000 bar for five minutes. Post-soaking was carried out for thirty seconds at a temperature of 15° C. The Scholle type bag was then drained and the solid spent material discarded. The raw liquid extract was then concentrated, dried and ground to form a final roasted coffee extract powder.

### Example 29

Roasted whole coffee beans were ground to a particle size of from 90 μm to 1000 μm in a standard cage mill grinder. The ground product was placed in a Scholle type bag and water was added to the ground product. The ratio of product to water was 1:5. Pre-soaking was carried out for ten minutes at a temperature of 32° C. Extraction of the ground product was then carried out at a temperature of 38° C., at a pressure of 2600 bar for one minute. Post-soaking was carried out for thirty seconds at a temperature of 15° C. The Scholle type bag was then drained and the solid spent material discarded. The raw liquid extract was then concentrated, dried and ground to form a final roasted coffee extract powder.

### Example 30

Roasted whole coffee beans were ground to a particle size of from 90 μm to 1000 μm in a standard cage mill grinder. The ground product was placed in a Scholle type bag and water was added to the ground product. The ratio of product to water was 1:5. Pre-soaking was carried out for ten minutes at a temperature of 32° C. Extraction of the ground product was then carried out at a temperature of 60° C., at a pressure of 4000 bar for eight minutes. Post-soaking was carried out for ten minutes at a temperature of 32° C. The Scholle type bag was then drained and the solid spent material discarded. The raw liquid extract was then concentrated, dried and ground to form a final roasted coffee extract powder.

### Example 31

Roasted whole coffee beans were ground to a particle size of from 90 μm to 1000 μm in a standard cage mill grinder. The ground product was placed in a Scholle type bag and water was added to the ground product. The ratio of product to water was 1:8. Pre-soaking was carried out for ten minutes at a temperature of 32° C. Extraction of the ground product was then carried out at a temperature of 60° C., at a pressure of 4000 bar for eight minutes. Post-soaking was carried out for ten minutes at a temperature of 32° C. The Scholle type bag was then drained and the solid spent material discarded. The raw liquid extract was then concentrated, dried and ground to form a final roasted coffee extract powder.

### Example 32

Roasted whole coffee beans were ground to a particle size of from 90 μm to 1000 μm in a standard cage mill grinder. The ground product was placed in a Scholle type bag and water was added to the ground product. The ratio of product to water was 1:5. Pre-soaking was carried out for ten minutes at a temperature of 20° C. Extraction of the ground product was then carried out at a temperature of 20° C., at a pressure of 6000 bar for five minutes. Post-soaking was carried out for ten minutes at a temperature of 20° C. The Scholle type bag was then drained and the solid spent material discarded. These conditions resulted in a yield of 15.4%. A second pass of the above extraction resulted in a yield of greater that 27%. The raw liquid extract was then concentrated, dried and ground to form a final roasted coffee extract powder.

### Example 33

Roasted whole coffee beans were ground to a particle size of from 90 μm to 1000 μm in a standard cage mill grinder. The ground product was placed in a Scholle type bag and water was added to the ground product. The ratio of product to water was 1:8. Pre-soaking was carried out for ten minutes at a temperature of 32° C. Extraction of the ground product was then carried out at a temperature of 70° C., at a pressure of 6000 bar for eight minutes. Post-soaking was carried out for ten minutes at a temperature of 32° C. The Scholle type bag was then drained and the solid spent material discarded. The raw liquid extract was then concentrated, dried and ground to form a final roasted coffee extract powder.

### Example 34

Roasted whole coffee beans were ground to a particle size of from 90 μm to 1000 μm in a standard cage mill grinder. The ground product was placed in a Scholle type bag and water was added to the ground product. The ratio of product to water was 1:8. Pre-soaking was carried out for ten minutes at a temperature of 70° C. Extraction of the ground product was then carried out at a temperature of 70° C., at a pressure of 6000 bar for eight minutes. Post-soaking was carried out for ten minutes at a temperature of 32° C. The Scholle type bag was then drained and the solid spent material discarded. The raw liquid extract was then concentrated, dried and ground to form a final roasted coffee extract powder.

### Example 35

Roasted whole coffee beans were ground to a particle size of from 90 μm to 1000 μm in a standard cage mill grinder. The ground product was placed in a Scholle type bag and water was added to the ground product. The ratio of product to water was 1:8. Pre-soaking was carried out for ten minutes at a temperature of 70° C. Extraction of the ground product was then carried out at a temperature of 70° C., at a pressure of 6000 bar for eight minutes. Post-soaking was carried out for ten minutes at a temperature of 70° C. The Scholle type bag was then drained and the solid spent material discarded. The raw liquid extract was then concentrated, dried and ground to form a final roasted coffee extract powder.

### Example 36

Roasted whole coffee beans were ground to a particle size of from 90 μm to 1000 μm in a standard cage mill grinder. The ground product was placed in a Scholle type bag and water was added to the ground product. The ratio of product to water was 1:8. Pre-soaking was carried out for ten minutes at a temperature of 70° C. Extraction of the ground product was then carried out at a temperature of 70° C., at a pressure of 6000 bar for eight minutes. Post-soaking was carried out for ten minutes at a temperature of 70° C. The Scholle type bag was then drained and the solid spent material and the liquid extract retained. The solid spent material was then subjected to the above extraction process again and the resulting second liquid extract was added to the liquid extract from the previous pass. The second solid spent material was again subjected to the above extraction process and the resulting third liquid extract was added to the liquid extract from the previous passes. The third solid spent material was discarded and the combined liquid extract was then concentrated, dried and ground to form a final roasted coffee extract powder.

### Comparative Example 1

Black tea leaves were ground to a particle size of from 90 μm to 1000 μm in a standard cage mill grinder and placed in a Scholle type bag. Water was added to the ground product in a ratio of 6:1. Pre-soaking was carried out for five minutes at a temperature of 32° C. Extraction of the ground product was then carried out at a temperature of 32° C., through steeping with no added pressure. Post-soaking was carried out for five minutes at a temperature of 32° C. The Scholle type bag was then drained and the solid spent material discarded. These conditions resulted in an extract with 0.12% soluble solids and yield of 9.4%.

While the present embodiments have been described with respect to the foregoing, those skilled in the art will readily appreciate that various changes and/or modifications can be made to the invention without departing from the spirit or scope of the embodiments as defined by the appended claims. In addition, while certain aspects of the present embodiments are presented below in certain claim forms, the inventors contemplate the various aspects of the invention in any available claim form.

Those skilled in the art will also appreciate that in some embodiments the functionality provided by the components, structures, methods and processes discussed above may be provided in alternative ways, such as being split among more components or methods or consolidated into fewer components or methods. In addition, while various methods may be illustrated as being performed in a particular order, those skilled in the art will appreciate that in other embodiments the methods may be performed in other orders and in other manners.

What is claimed is:

1. An edible composition comprising:
an extract of an edible substance;
the extract resulting from extraction of the edible substance in an extraction medium comprising water at an extraction temperature of from about 0° C. to about 80° C. and at an extraction pressure of at least about 2000 bar.

2. The edible composition of claim 1, wherein the extraction pressure is at least about 2600 bar.

3. The edible composition of claim 1, wherein the extraction pressure is at least about 3000 bar.

4. The edible composition of claim 1, wherein the extraction pressure is at least about 5000 bar.

5. The edible composition of claim 1, wherein the extraction temperature is from about 0° C. to about 60° C.

6. The edible composition of claim 1, wherein the extraction temperature is from about 5° C. to about 30° C.

7. The edible composition of claim 1, wherein the extraction medium consists of water.

8. The edible composition of claim 1, wherein the edible substance comprises coffee.

9. The edible composition of claim 1, wherein the edible substance comprises green coffee beans.

10. The edible composition of claim 1, wherein the edible substance comprises roasted whole coffee beans.

11. The edible composition of claim 1, wherein the edible substance comprises one or more of green tea leaves, partially dehydrated tea leaves and totally dehydrated tea leaves.

12. The edible composition of claim 1, wherein the edible substance comprises at least one of green coffee cherries, red coffee cherries, coffee flowers, coffee cherry skin, coffee cherry pulp, coffee cherry stalk, coffee cherry silverskin, coffee cherry mucilage, coffee cherry parchment, coffee cherry exocarp, green coffee beans and coffee cherry mesocarp.

13. The edible composition of claim 1, wherein the extract has been dried.

14. The edible composition of claim 13, wherein the extract has been dried by at least one of freeze drying, filter-mat drying, fluid bed drying, spray drying, thermal evaporation and zeodration.

15. The edible composition of claim 1, further comprising at least one of a coffee component, a tea component, a cocoa component, a chocolate component, a sweetener component and a flavoring component.

16. The edible composition of claim 1, further comprising at least one of a coffee extract, concentrated coffee, dried coffee, coffee oils, soluble coffee, coffee aromas, distillates, flavor powders, flavor oils, spices, ground or pulverized cocoa beans, ground or pulverized vanilla beans, vitamins, antioxidants, wellness components, nutraceuticals, dietary fiber, an omega-3 oil, an omega-6 oil, an omega-9 oil, a flavonoid, lycopene, selenium, a beta-carotene, resveratrol, inulin, beta glucan, 1-3,1-6-beta-glucan, barley beta-glucan, barley b-glucan, a vegetable extract, a dry green coffee extract, a wet green coffee extract, pulverized coffee, roast coffee, roast and ground coffee, soluble coffee including pulverized coffee and an herbal extract.

17. A beverage comprising the edible composition of claim 1.

18. The beverage of claim 17, wherein the extraction pressure is at least about 2600 bar.

19. A method of making an edible composition, the method comprising:
extracting an edible substance in an extraction medium at an extraction temperature and at an extraction pressure to form an extract of the edible substance; and
processing the extract of the edible substance to form the edible composition,
wherein the extraction medium comprises water, and
wherein the extraction pressure is at least about 2000 bar.

20. The method of claim 19, wherein the extraction pressure is at least about 2600 bar.

21. The method of claim 19, wherein the extraction pressure is at least about 3000 bar.

22. The method of claim 19, wherein the extraction pressure is at least about 5000 bar.

23. The method of claim 19, wherein the extraction temperature is from about 0° C. to about 60° C.

24. The method of claim 19, wherein the extraction temperature is from about 5° C. to about 30° C.

25. The method of claim 19, wherein the extraction medium consists of water.

26. The method of claim 19, wherein the edible substance comprises coffee.

27. The method of claim 19, wherein the edible substance comprises green coffee beans.

28. The method of claim 19, wherein the edible substance comprises roasted whole coffee beans.

29. The method of claim 19, wherein the edible substance comprises one or more of green tea leaves, partially dehydrated tea leaves and totally dehydrated tea leaves.

30. The method of claim 19, wherein the edible substance comprises at least one of green coffee cherries, red coffee cherries, coffee flowers, coffee cherry skin, coffee cherry pulp, coffee cherry stalk, coffee cherry silverskin, coffee cherry mucilage, coffee cherry parchment, coffee cherry exocarp, green coffee beans and coffee cherry mesocarp.

31. The method of claim 19, wherein the processing comprises drying or packaging as a liquid extract.

32. The method of claim 31, wherein the drying comprises at least one of freeze drying, filter-mat drying, fluid bed drying, spray drying, thermal evaporation and zeodration.

33. The method of claim 19, further comprising adding to the extract of the edible substance at least one of a coffee component, a tea component, a cocoa component, a chocolate component, a sweetener component and a flavoring component.

34. The method of claim 19, further comprising adding to the extract of the edible substance at least one of a coffee extract, concentrated coffee, dried coffee, coffee oils, soluble coffee, coffee aromas, distillates, flavor powders, flavor oils, spices, ground or pulverized cocoa beans, ground or pulverized vanilla beans, vitamins, antioxidants, wellness components, nutraceuticals, dietary fiber, an omega-3 oil, an omega-6 oil, an omega-9 oil, a flavonoid, lycopene, selenium, a beta-carotene, resveratrol, inulin, beta glucan, 1-3,1-6-beta-glucan, barley beta-glucan, barley b-glucan, a vegetable extract, a dry green coffee extract, a wet green coffee extract, pulverized coffee, roast coffee, roast and ground coffee, soluble coffee including pulverized coffee and an herbal extract.

35. The method of claim 19, further comprising one or more of grinding the edible substance before extraction, grinding the extract of the edible substance after drying, concentrating the edible substance or extract, filtering the edible substance or extract, pre-soaking the edible substance before extraction and post-soaking the extract after extraction.

36. A method of making a beverage, the method comprising:
preparing an edible composition according to the method of claim 19; and
adding the edible composition to one or more other beverage components to form the beverage.

37. The method of claim 36, wherein the extraction pressure is at least about 2600 bar.
